(19) United States
(12) Patent Application Publication
(10) Pub. No.: US 2006/0172564 A1
(43) Pub. Date: Aug. 3, 2006

(54) Testing of interconnections between stacked circuit boards

(76) Inventors: Mattias Nilsson, Goteborg (SE); Stefan Johansson, Vastra (SE)

Correspondence Address: ERICSSON INC., 6300 LEGACY DRIVE, M/S EVR C11, PLANO, TX, 75024, US

(21) Appl. No.: 10/595,034

(22) PCT Filed: Jul. 7, 2003
(86) PCT No.: PCT/SE03/01183

§ 371 Date: Jan. 5, 2006

(51) Int. Cl. H01R 12/00

(52) U.S. Cl. 439/66

(57) ABSTRACT

A retainer board (25, 27, 28) having at least one hole (10) in which a wire button contact (5) is inserted, wherein the hole (10) is plated and at least one conductor (20) is connected to the plated hole for providing outside access. Moreover a method for testing stacked circuit boards are disclosed comprising the steps of detachably arranging at least two circuits boards (11, 12, 29), testing the individual functionality of the circuit boards (11, 12) and if approved, assembling the circuit boards (11, 12) and the first retainer board (25, 27, 28), and asserting whether the overall functionality of the arrangement is approved.

### FIELD OF THE INVENTION

The present invention relates to the field of interconnections in 3-dimensional interconnect structures and in particular solderless “z-axis” interconnections. The invention also relates to testing of such connections.

### BACKGROUND

Wire buttons may be used in applications such as Land Grid Array integrated circuit socket to printed circuit board (PCB) connections and for parallel PCB to PCB interconnections. One known type of wire button is manufactured from gold plated molybdenum wires and is compressed into a cylindrical space. Since wire buttons provide a spring-forced connection, they may be used in test beds allowing interchangeable connections to various components or circuits.

In prior art document “a review of 3D packaging technology”, by S F Al-sarawi, IEEE transactions on components, packaging and manufacturing technology—Part B, vol. 21, No. 1 February 1998, an array of fuzz button contacts are used to provide the vertical interconnections between stacked PCB's.

Prior art document “Wire button contact retainer board for 3-D Interconnected MCMs” by R. E. Ackerman and Dean Schaefer, Intl. Journal of Microelectronics and Packaging Society, Vol. 19, No. 4, 1996 deals with the production of multichip modules with very high packaging and interconnect densities.

The above document shows a test vehicle comprising vertically stacked demountable MCM's, which are connected in the z-axis by alternately stacked wire button contact retainer boards. In FIGS. 5 and 6, page 458-459 of this document a retainer board is shown, which comprises a rigid/flex Kapton™ board 15 with wire button contact retainer boards 14, 16 laminated on both sides. The laminated layers comprise opposing wire button contacts 5 that are interconnected by a plated through hole 9 in the Kapton™ board. The wire button retainer board provides vertical connection between respective interconnect layers 7 of the stacked MCM's 12, 11 and provide flex circuit layers 20, which can be connected to a test I/O (input/output) backplane.

Compression bolts hold the stacked structure together. If the impedance of interconnections in individual terminals is not within tolerances, the affected respective MCM may be replaced. FIG. 1 of the present application is an attempt of a schematic representation of the above FIGS. 5 and 6. The button contacts are countersinked (not shown) on the wire button contact retainer boards.

In U.S. Pat. No. 5,619,399 a mounting assembly for a chip module or other circuit module is shown. The interposer comprises a rigid or flexible plate with an array of wire buttons through the plate, arranged such that when pressure is applied to the array of wire buttons, electrical connections is made between contacts on either side of the plate, that is, between respective contacts on the circuit module and board contacts on a printed wire board.

U.S. Pat. No. 5,886,590 shows a coax to microstrip orthogonal launcher utilising a wire button centre conductor as a solderless interconnect.

### SUMMARY OF THE INVENTION

It is a first object of the present invention to set forth a retainer board, which allows for accurate tolerances in x and y levels and a low build height in the z-axis while providing for the possibility for outside signal access.

This object has been accomplished by the subject matter set forth in claim 1.

It is a further object to set forth an arrangement for testing.

This object has been accomplished by claim 3.

It is a further object to set forth an assembly and testing method providing accurate control possibilities.

This object has been accomplished by the subject matter defined by claim 5.

Further advantages will appear from the following detailed description of the invention.

### BRIEF DESCRIPTION OF THE FIGURES

FIG. 1 shows a schematic representation of a prior test vehicle with a retainer board,

FIGS. 2, 3 and 4 shows a preferred embodiment of a retainer board according to the invention,

FIG. 5 shows an excerpt of first embodiment of a device providing probes for outside testing,

FIG. 6 shows an exemplary device, which is accomplished according to a preferred method according to the invention,

FIG. 7 shows an excerpt of a second embodiment of a device providing probes for outside testing comprising a multi layer retainer board, and

FIG. 8 shows an excerpt of a third embodiment of a device providing probes for outside test in which more than two retainer boards are present.

### DETAILED DESCRIPTION OF PREFERRED EMBODIMENTS OF THE INVENTION

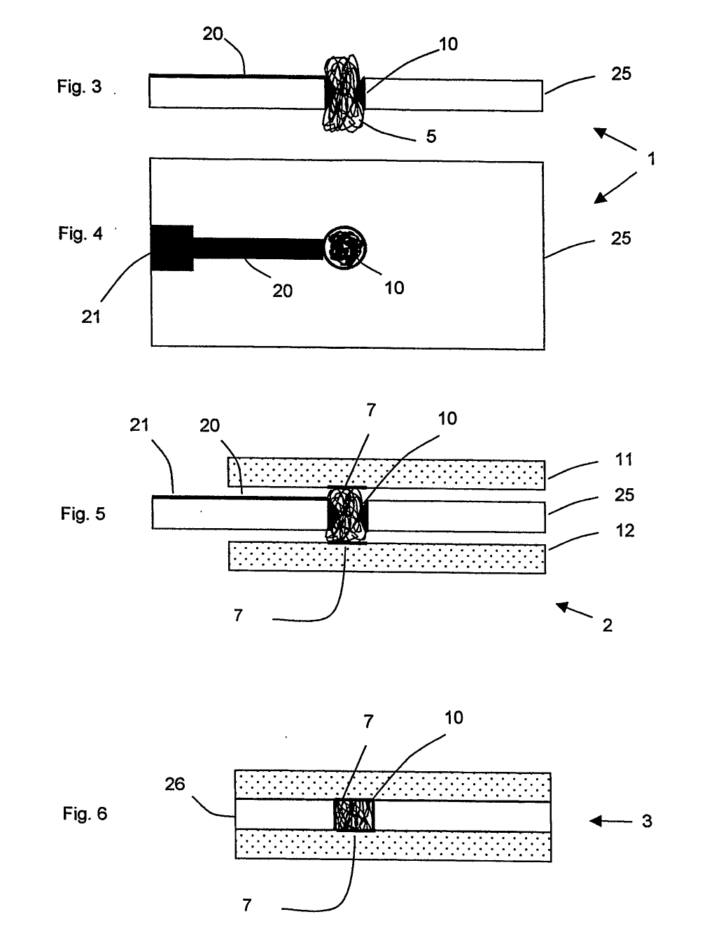

In FIGS. 2, 3 and 4, a preferred retainer board 1 according to the invention has been shown. The retainer board consist of a board 25 having at least one plated hole 10. At least one conductor 20 being in connection with the plated hole 10 is formed on one side of the board. In the plated hole 10, which has countersinked faces 13 on both sides, a wire contact 5 is inserted and compressed, such that it is fixed to the retainer board. The retainer board may be a printed circuit board (PCB). The retainer board may be a single layer or a multi layer board. The wire button may be purchased from CIN::APSE® or Tecknit®. The physical dimensions of the plated hole as well as the height of the retainer board could typically be in the region of one mm.

In FIG. 5, an arrangement 2 comprising at least two Circuit boards 11 and 12, which may carry any number of components (not shown), are illustrated as being in the process of being interconnected by the retainer board 25 according to the invention. Each respective circuit board 11, 12 comprises at least a pair of circuit board terminals 7, which provide interconnections in the z-direction by means of suitable vertical connections (not shown) such as filled vias or surface plated contacts. The retainer board protrudes beyond the circuit boards, whereby an I/O terminal 21 being in connection with the conductor 20 is accessible for probe purposes.

According to a preferred method of the invention, the circuit boards 11,12 may first be tested individually to the extent possible, keeping in mind that the physical dimensions of test probes (not shown) and the physical distance between the circuit boards 11, 12 and the test equipment (not shown) afflict restrictions on the test.

Upon approval, the circuit boards 11, 12 may be assembled in a test configuration with the retainer board 25 as shown in FIG. 5, providing probe points of the connections defined by the retainer board 25. In the test configuration, the circuit boards 11, 12 are detachably connected by suitable clamping as is known in the art. It is asserted whether the overall functionality of the arrangement is approved.

Upon overall approval of the arrangement, it can be fixingly assembled. In FIG. 6, the final operative device 3 accomplished by the invention is shown where the retainer board 26 exclusively functions as an interconnection means between the at least two circuit boards 11, 12. The retainer board 26 is clamped or glued to the latter circuit boards 11, 12 such that a permanent connection between the circuit boards is accomplished.

Subsequently, the protruding portion providing outside access of the retainer board may be cut off.

Alternatively, upon the overall approval of the arrangement, the first retainer board 25, 27, 28 may be removed and a second retainer board 26 may be inserted. The second retainer board 26 is substantially identical to the first retainer board 25, with the exception that the retainer board 26 does not necessarily have a conductor being in contact with the plated hole nor necessarily have I/O terminals for external contact.

Advantageously, the second retainer board 26 is produced on the same tools as the first retainer board 25, 27, 28, but where the portion and means providing outside access are omitted.

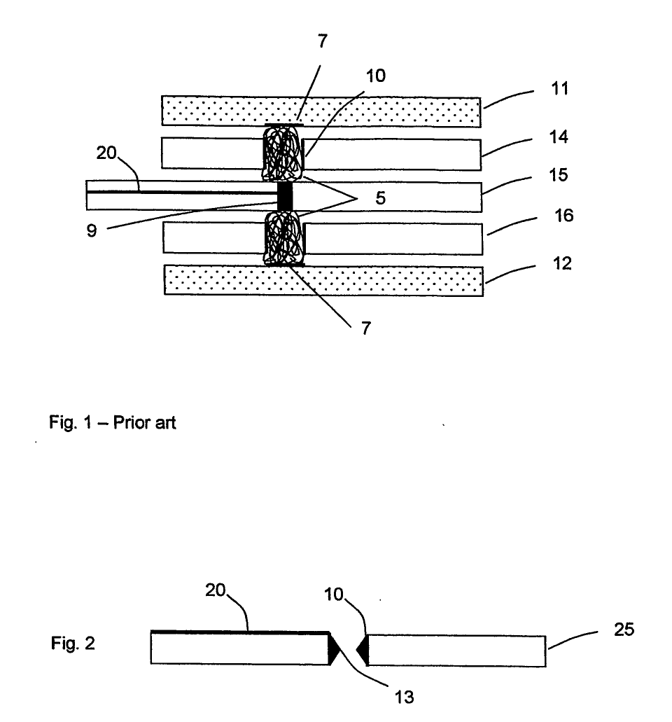

As would appear from a comparison with the structure shown in FIG. 1, the number of interfaces between the at least two circuit boards 11, 12 to be connected is reduced from four to two while providing the possibility for outside signal access. The high frequency properties of the connection according to the present invention are thereby enhanced in relation to the prior art, as every interface potentially may introduce reflections. Moreover, as the connection according to the invention consist of only one wire button contact instead of two, the building height can be at least halved. In high-speed and microwave applications, the performance may stand in proportion to the reduction of the physical dimensions.

As moreover appears from the description above, the retainer boards 25 for test purpose may be produced on the same tools as the final retainer board 26 shown in FIG. 6. Since, the retainer boards are close to identical, an accurate control of the performance of the final product is achieved.

According to a further aspect of the invention, the second retainer board 26 may be produced from the first retainer board by simply cutting off the protruding section shown in FIG. 5. In this case the terminal 21 is removed but the conductor 20 is retained.

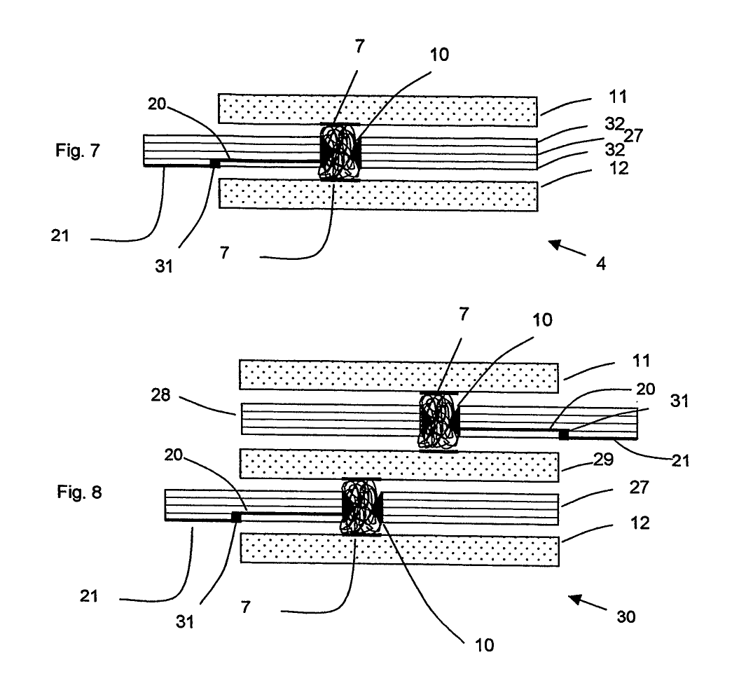

In FIG. 7 an arrangement 4 comprising circuit boards 11 and 12 and a multilayer retainer board 27 is shown. A conductor 20 is in electrical connection with the plated hole 10. Dielectric layers 32 constitute the outer layers of a mid section of the multilayer retainer board 27, such that the terminal 20 is electrically isolated from other wire button contacts (not shown). An I/O terminal 21 is provided on a section of the multilayer retainer board protruding beyond the circuit boards 11, 12 through via 31.

An assembly of three circuit boards 11, 12, 29 and two retainer boards 27, 28 is illustrated in FIG. 8.

1-9. (canceled)

10. A method for producing and testing an arrangement of stacked circuit boards, said method comprising the steps of:
detachably arranging at least two circuit boards having a pair of opposing circuit board terminals and a first retainer board having at least one plated hole into which a wire button contact is inserted, wherein at least one conductor is connected to the hole for providing outside access to the wire button contact, the wire button contact providing electrical connection between the pair of opposing circuit board terminals of the two circuit boards;
testing the individual functionality of the circuit boards; and,
assembling the circuit boards and the first retainer board, and ascertaining whether the overall functionality of the arrangement is acceptable.

11. The method according to claim 10, wherein upon overall acceptance of the arrangement, fixedly assembling the arrangement.

12. The method according to claim 10, wherein the retainer board is a multilayer board wherein dielectric layers constitute the outer layers of a mid section of the multilayer retainer board).

13. The method according to claim 10, further comprising the step, subsequent to said acceptance, of inserting a second retainer board which is substantially identical to the first retainer board.

14. An arrangement of stacked circuit boards adapted for testing thereof, comprising:
at least two circuit boards having a pair of opposing substrate terminals;
a retainer board having at least one plated hole into which a wire button contact is inserted, wherein at least one conductor is connected to the plated hole for providing outside access to the wire button contact, the wire button contact providing electrical connection between the pair of opposing circuit board terminals of the circuit boards.

15. The arrangement according to claim 14, wherein the retainer board is a multilayer board wherein dielectric layers constitute the outer layers of a mid section of the multilayer retainer board.
